(19) United States
(12) Patent Application Publication
(10) Pub. No.: US 2017/0360009 A1
(43) Pub. Date: Dec. 21, 2017

(54) HANDS FREE CANINE WALKER AND ACCESSORY CARRYING DEVICE

(71) Applicant: Todd ANDERSON, Pottstown, PA (US)

(72) Inventor: Todd ANDERSON, Pottstown, PA (US)

(21) Appl. No.: 15/411,597

(22) Filed: Jan. 20, 2017

Related U.S. Application Data
(60) Provisional application No. 62/430,429, filed on Dec. 6, 2016.
(60) Provisional application No. 62/392,962, filed on Jun. 16, 2016.
(60) Provisional application No. 62/392,961, filed on Jun. 16, 2016.

(51) Int. Cl. A01K 27/00; A45F 3/02; A45F 3/00

(52) U.S. Cl. CPC A01K 27/008; A45F 3/02; A01K 27/005; A01K 27/003; A45F 2003/001; A45F 2003/003

(57) ABSTRACT

An apparatus for walking an animal, the apparatus including a wearable strap for positioning over a shoulder of a user. The strap has a front portion and a back portion. An attachment device is positioned between the front portion and the back portion. The attachment device is positioned at the bottom of the strap and configured to receive a leash therein. The positioning of the attachment device at the bottom of the canine handling apparatus allows the forces from the leash to be applied to the waistline of the user. A storage pouch is releasably attached to the strap. The storage pouch is configured to store and dispense waste bags and for receiving and containing waste bags filled with waste.

### CROSS-REFERENCE TO RELATED APPLICATION

This patent application claims the benefit of U.S. Provisional Patent Application Ser. No. 62/430,429 filed on Dec. 6, 2016, and entitled “GEARTAC K9”, 62/392,962 filed on Jun. 16, 2016, and entitled “GEARTAC K9”, and 62/392,961 filed on Jun. 16, 2016, and entitled “GEARTAC TAGH1,” the disclosures of which are incorporated by reference as if fully rewritten herein.

### FIELD OF THE INVENTION

The present invention is directed to a hands free canine walker device to which a standard leash may be attached. More particularly, the invention is directed to a hands free canine walker bandolier which allows for the carrying of accessories and other items.

### BACKGROUND OF THE INVENTION

A number of canine leashes are known in the prior art. While each leash has its own unique benefits, many leashes require the canine owner or walker to hold the leash with his/her hands. If the canine is a large breed, it can be extremely difficult for the owner or walker to hold onto or control the leash when the canine pulls. Wrapping the leash around the body can help solve this problem by giving the handler or walker greater leverage, however it can also be dangerous, because if the canine pulls too hard, the leash may injure the part of the body to which it is tethered. A hands free canine walker is needed that is safe for general use.

In addition, many canine owners like to carry canine accessories, such as toys or disposal bags, or other items, such as keys and phones, when they take canines for walks. However, conventional leashes do not provide any place to store or carry such items. Consequently, canine owners often carry knapsacks or the like with them when they take their canines for walks.

It would be desirable to provide a wearable canine walker device to which a standard leash may be attached, thereby allowing the owner's hands to remain free. It would also be desirable to provide a hands free canine walker device which allows for the carrying of accessories and other items.

### SUMMARY OF THE INVENTION

An object is to provide a hands free canine walking or handling device or apparatus designed for the everyday use of carrying accessories and walking the canine. This provides the advantage to throw a small, lightweight, unobtrusive apparatus or device over the shoulder.

An object is to provide a bandolier to which a standard leash can be attached and which can carry accessories in a safe and secure manner, the bandolier having the ability to add or subtract pouches as needed. For city use, one might attach pouches for a cell phone, car keys, credit cards and gym membership. On the other hand, an individual on a hike might like a water bottle sleeve, camera pouch, key holder and flashlight clip. The options are endless and up to the individual.

An object is to provide a hands free canine walking or handling device or apparatus which can store and dispense canine waste bags and also receive and contain waste after the canine has evacuated his or her fecal matter. Having the ability to take your canine for a walk and pick up his or her waste and then store that waste in the pouch allows for the canine owner to easily pick up, remove and later dispose of the waste while respecting the laws and ordinances in most cities and towns.

An object is to provide a hands free canine walking or handling device or apparatus to which a standard canine leash is easily attached the bandolier. Having this ability allows the canine walker the safety of having both hands free in case of a fall. It also provides the walker with added strength due to the cross body nature of the bandolier. The bandolier now spreads the load of a pulling canine across the entire back of the individual as opposed to stressing the arm and shoulder joints.

An object is to provide a wearable hands free canine walking or handling device or apparatus which lowers the center of gravity of the pulling canine to the mid-section of the individual increasing their ability to restrain their canine.

An embodiment is directed to an apparatus for walking an animal, the apparatus including a wearable strap for positioning over a shoulder of a user. The strap has a front portion and a back portion. An attachment device is positioned between the front portion and the back portion. The attachment device is positioned at the bottom of the strap and configured to receive a leash therein. The positioning of the attachment device at the bottom of the canine handling apparatus allows the forces from the leash to be applied to the waistline of the user. A storage pouch is releasably attached to the strap. The storage pouch is configured to store and dispense waste bags and for receiving and containing waste bags filled with waste.

An embodiment is directed to an apparatus for walking an animal, the device comprising a wearable strap for positioning over a shoulder of a user. The strap has a front portion and a back portion. An attachment device is positioned between the front portion and the back portion. The attachment device is positioned at the bottom of the strap and configured to receive a leash therein. A storage pouch is releasably attached to the strap. The storage pouch is configured to store and dispense waste bags and for receiving and containing waste bags filled with waste. Release buckles are provided in the front portion of the strap. The release buckles provide a quick safety release when the user must quickly exit the canine handling apparatus. The strap is dimensioned and fitted to allow the strap to rotate around the users shoulder in a fashion that the attachment device moves from front to back from approximately the 4 to 8 o'clock positions of the user, eliminating direct pressure on the user from the canine and providing the user with the ability to prepare for the canines' movements without a jerking motion.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an individual controlling a canine with the use of an illustrative hands free canine handling apparatus according to the present invention, the canine handling apparatus is positioned over the shoulder of the individual and has an illustrative canine leash connected to the canine handling apparatus.

FIG. 2 is a front view of the hands free canine handling apparatus shown in FIG. 1.

FIG. 3 is a back view of the hands free canine handling apparatus shown in FIG. 1.

FIG. 4 is a side view of the hands free canine handling apparatus shown in FIG. 1.

FIG. 5 is a front view of the hands free canine handling apparatus shown in FIG. 2 with an illustrative storage pouch attached to a back strap of the canine handling apparatus.

FIG. 6 is a back view of the hands free canine handling apparatus shown in FIG. 5 with the storage pouch attached to a back strap of the canine handling apparatus.

FIG. 7 is a side view of the hands free canine handling apparatus shown in FIG. 5 with the storage pouch attached to a back strap of the canine handling apparatus.

FIG. 8 is a perspective view of the storage pouch, shown in FIG. 5, removed from the canine handling apparatus.

FIG. 9 is a perspective view of an illustrative release buckle which may be used with the hands free canine handling apparatus. The release buckle is shown in an open position.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

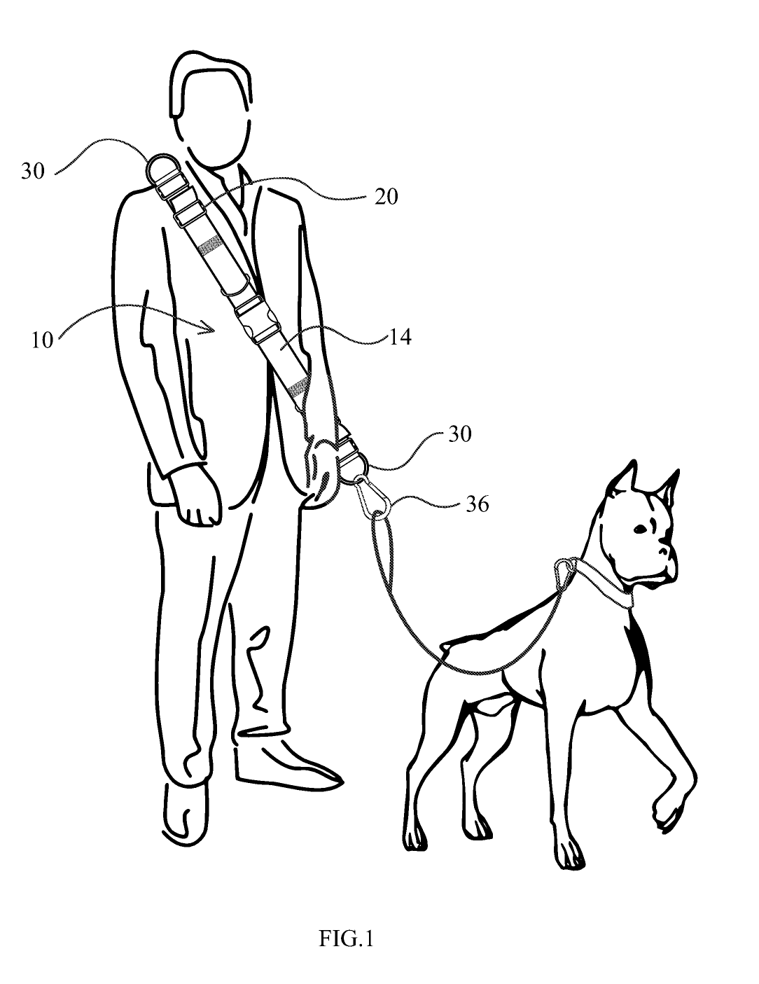

As shown in FIG. 1, the hands free animal or canine handling apparatus 10 is configured to be worn over a shoulder of a user. The hands free canine handling apparatus 10 is designed for the everyday use of walking or training a canine or other animal. Additionally, the hands free canine handling apparatus 10 may be used to carry accessories. A bandolier by definition is a shoulder-belt with loops or pockets for cartridges. The hands free canine handling apparatus 10 allows a user to carry daily accessories, in a safe secure environment, with the ability to add or subtract pouches based on the user's preferences. Whether living in the city and riding the subway to work, or taking a hike on a mountain trail, the hands free canine handling apparatus 10 can be adapted to meet the needs of the user. For example, for city use, the user might attach pouches for a cell phone, car keys, credit cards and gym membership. Alternatively, a user on a hike might like a water bottle sleeve, camera pouch, key holder and flashlight clip. The hands free canine handling apparatus 10 may also have a pouch attached to the rear of the device to serve as a storage sleeve for canine waste bags and also as a receptacle to contain waste after the canine has evacuated his or her fecal matter. Having the ability to take a canine for a walk and pick up his or her waste and then store that waste in the pouch allows for the canine owner to easily pick up, remove and later dispose of the waste while respecting the laws and ordinances in most cities and towns. The hands free canine handling apparatus 10 also functions as a hands free walker by attaching a standard canine leash, as will be more fully described. Having this ability allows the user the safety of having both hands free in case of a fall. It also provides the user with added strength due to the cross body nature of the hands free canine handling apparatus 10. The hands free canine handling apparatus 10 now spreads the load of a pulling canine across the entire back of the user as opposed to stressing the user's arms and shoulder joints.

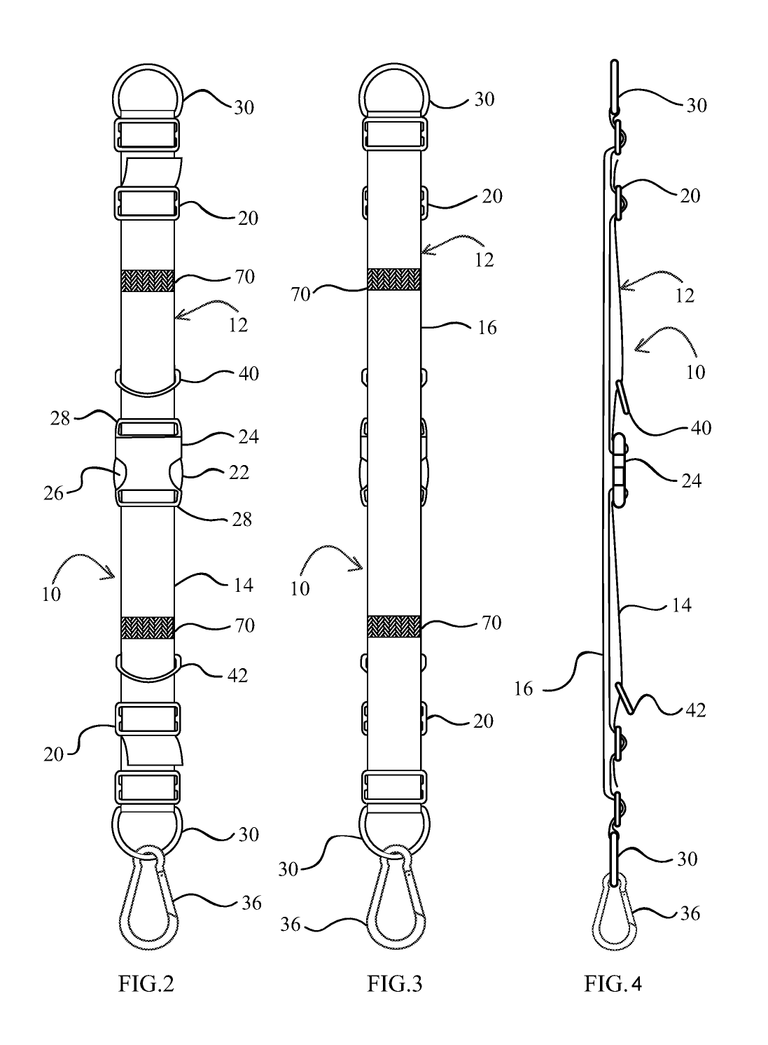

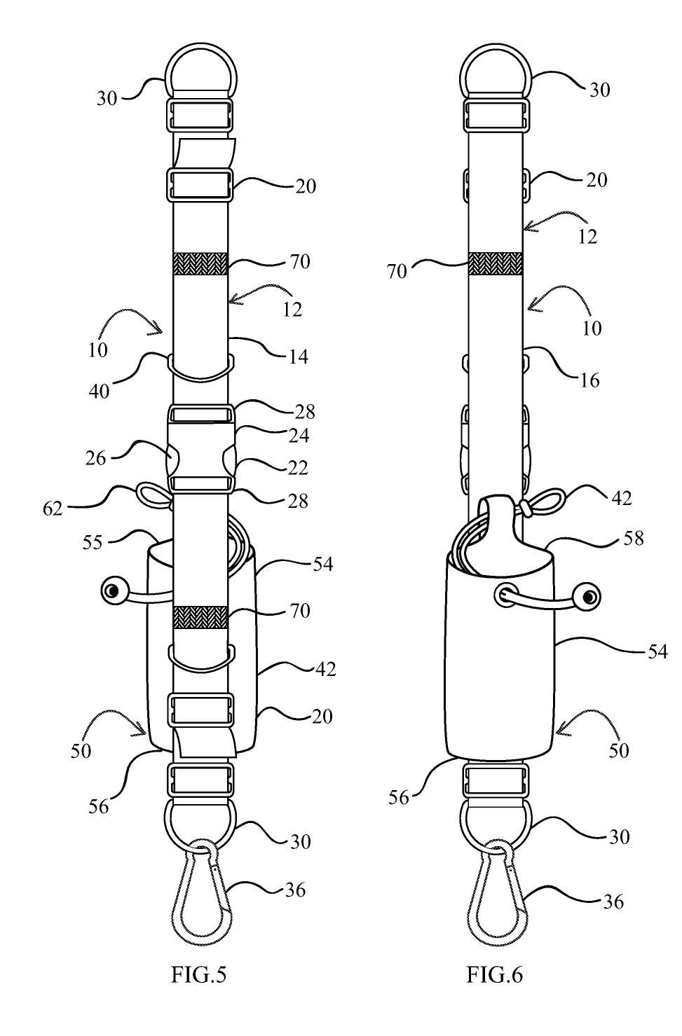

As best shown in FIGS. 2 through 7, hands free canine handling apparatus 10 comprises a wearable main strap 12 which has a front portion 14 and a back portion 16. The front portion 14 is positioned over the front of the user and the back portion 16 is positioned over the back of the user. In the illustrative embodiment shown, the strap 12 is made from 2″ MIL-W-17337 mil-spec nylon webbing with a breaking strength of 2200 lbs, a weight of 1.2 oz/yd and thickness of between 0.038 and 0.050 inches. However, other material with other material properties can be used without departing from the scope of the invention. Such materials may include, but are not limited to, cotton, vinyl, polypropylene, nylon, polyester, elastic, wool or leather. Regardless of the material used, the strap must have sufficient tensile strength to withstand the force of a canine pulling (as will be more fully described) without failure.

In the illustrative embodiment shown, the strap 12 has an approximately 2 inch wide webbing. This allows the strap 12 to have sufficient tensile strength while allowing the canine handling apparatus 10 and the strap 12 to rotate around the torso of the user when a canine pulls forward or back. This action frees the user's shoulders and arms from strain, thereby minimizing the potential of injury to the shoulders and arms. In addition, as the strap 12 extends across the user's body (as shown in FIG. 1), the strap 12 distributes the force associated with the canine pulling evenly around the large mass of the user's torso and back, helping the user maintain control of the canine.

In the embodiment shown, the front portion 14 of the strap 12 has one or more strap adjustment slides or first slides 20 which allow the strap 12 to be adjusted to properly fit the user's body. The adjustment slides 20 operate in a manner known in the industry to adjust the length of front portion 14 and the strap 12. In alternate embodiments, the adjustment slides 20 may be located on the back portion 16 or on both the back portion 16 and the front portion 14. The slides 20 may be made of plastic, metal or other material which allows the strap 12 to be inserted and moved relative thereto.

Double adjust side release buckles 22, 24, as best shown in FIG. 9, are provided in the front portion 14 of the strap 12. The release buckles 22, 24 allow the user to engage and move the latches 26 toward each other when the canine handling apparatus 10 is to be removed from the user. When positioned on the user, the buckles 22, 24 are moved together such that the latches 26 are resiliently deformed by the buckle 24 until the latches 26 are snapped into position in the buckle 24. In this position, the buckles 22, 24 prevent the inadvertent opening of the buckles 22, 24. However, the buckles 22, 24 provide a quick safety release when the user must quickly exit the canine handling apparatus 10. For example, if a sufficient force is applied to the strap 10, the buckles 22, 24 release to prevent injury to the user. The specific force may be designed according to need and application. The release buckles 22, 24 have double slide web engaging members 28 provided thereon for removably attaching the webbing of the front portion 14 of the strap 12 to the release buckles 22, 24.

The canine handling apparatus 10 has an attachment device, such as, but not limited to, a D-ring 30 at the top of the apparatus 10, positioned between the front portion 14 of the strap 12 and the back portion 16. The D-ring 30 may be used for various purposes, including as a hanging mechanism to hang the canine handling apparatus 10 when not in use. The D-ring 30 also provides a mount point if the canine handling apparatus 10 is used to hold high loads of weight. In the embodiment shown, the D-ring 30 is made from ¼ inch metal wire, but other material may be used.

The canine handling apparatus 10 has an attachment device, such as, but not limited to, a D-ring 32 at the bottom of the apparatus 10, positioned between the front portion 14 of the strap 12 and the back portion 16. The D-ring 32 may be used for various purposes, including attaching a leash to for hands free canine walking. In the embodiment shown, the D-ring 30 is made from ¼ inch metal wire, but other material may be used. In one exemplary embodiment, the D-ring 32 is used to hold a spring snap mechanism 36, such as a carabiner, or other holding device which can be attached to a leash. The positioning of the D-ring 32 and the leash at the bottom of the canine handling apparatus 10 allows the user to lower the center of gravity of the applied forces from the shoulders to the waistline increasing the user's ability to hold and maintain the canine.

Attachment device adjustment slides or second adjustment slides 34 are provide proximate the D-rings 30, 32. The adjustment slides 34 allow the D-rings 30, 32 to be properly positioned as the length of the strap 12 is adjusted. The adjustment slides 34 operate in a manner known in the industry. The slides 34 may be made of plastic, metal or other material which allows the strap 12 to be inserted and moved relative thereto.

In the illustrative embodiment shown, the canine handling apparatus 10 has two additional accessory attachment devices, such as, but not limited to, D-rings 40, 42 on the front portion 14 of the strap 12. The b-rings 40, 42 can be made from plastic, metal or other material which has sufficient strength to hold ancillary devices, such as, but not limited to a flashlight or pepper spray. Other numbers of D-rings may be provided without departing from the scope of the invention. Additional D-rings may also be provided on the back portion 16 of the strap 12. In addition, other removable or addable devices may be used in place of or in addition to D/rings 40, 42, such as, but not limited to: Velcro, snaps, clips, fasteners, magnetic strips or any combination thereof. The implementation of these affixing techniques is readily apparent to one of ordinary skill in the art. The use of the D-rings 40, 42 and other devices allows for the user to customize the type and quantity of carry items attached to the strap 12 of the canine handling apparatus 10.

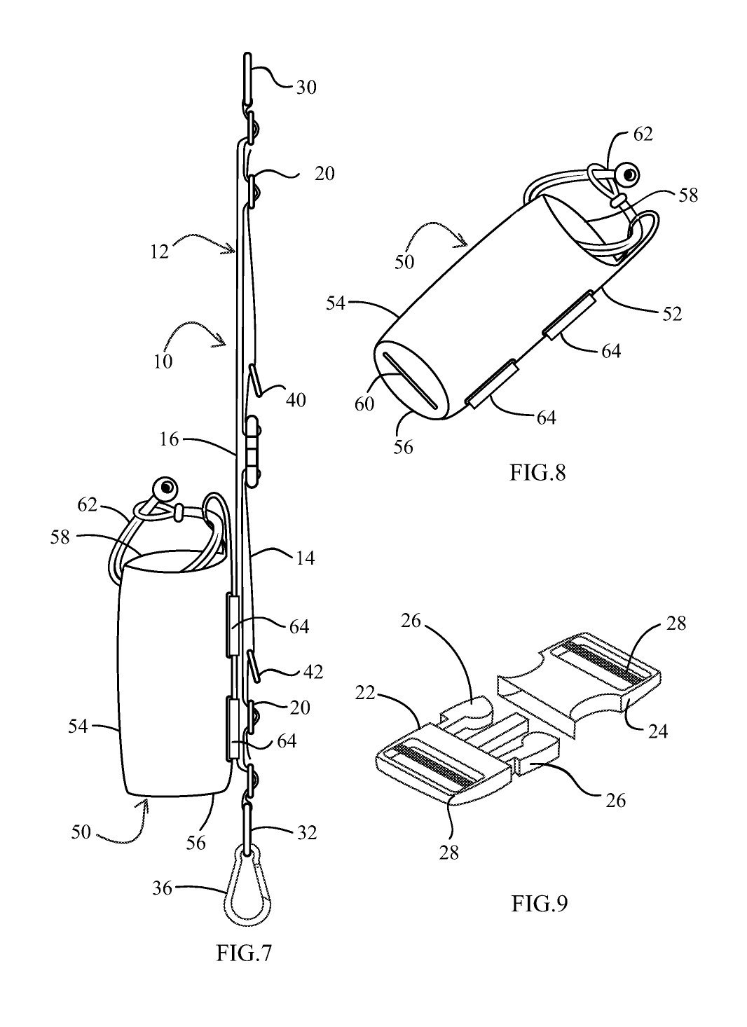

As best shown in FIGS. 5 through 8, a storage pouch 50 may be provided on the back portion 16 of the strap 12 of the canine handling apparatus 10. In the illustrative embodiment best shown in FIG. 8, the storage pouch 50 has a cylindrical storage compartment 52 with a side wall 54, a bottom wall 56 and an open top 58. The bottom wall 56 has an opening or slot 60 provided therein. Proximate the open top 58, a pull cord 62 is provided. The pull cord 62 allows the top 58 to be pulled closed as needed. Extending from the side wall 54 are one or more attachment strips 64. The attachment strips 64 are wrapped around the back portion 16 of the strap 12 and secured thereto, as best shown in FIG. 7. In the embodiment shown, the storage pouch 50 works as a storage sleeve for canine waste bags. The bags are inserted through the open top 58. The bags can be removed either through the open top 58 or through the slot 60 in the bottom wall 56. The storage pouch 50 also acts as a receptacle to contain bags filled with waste after the canine has evacuated his or her fecal matter. Having the ability to take a canine for a walk and pick up his or her waste and then store that waste in the storage pouch 50 allows for the user to easily pick up, remove and later dispose of the waste while respecting the laws and ordinances regarding waste clean-up and disposal. While the illustrative embodiment shows the storage pouch 50 attached by Velcro attachment strips 64, other attachment strips or devices such as, but not limited to, snaps, clips, fasteners and magnetic strips may be used.

In alternate embodiments, additional storage pouches 50 may be provided. Such pouches may have different configurations and may use different attachment devices, but are easily positioned on and removed from the strap 12 as needed. Such storage pouches 50 may be used, for example, for a cell phone, car keys, credit cards, water bottles, camera or key holder.

In alternate embodiments, the canine handling apparatus 10 and/or the storage pouch 50 may include reflective panels, painted areas or fibers 70 which are visible at night or in less than ideal conditions.

In use, when worn by the user, the canine handling apparatus 10 is worn (the front portion 14 and back portion 16 are dimensioned and fitted) in a manner to have sufficient movement to rotate around the torso of the user when a canine pulls forward or back. The strap 12 of the canine handling apparatus 10 can rotate around the users shoulder in a fashion that the D-ring 32 at the bottom of the canine handling apparatus can move from front to back from approximately the 4 to 8 o'clock positions if looking at a side profile of the user. This mobility eliminates direct pressure on the user from the canine and provides the user with the ability to prepare for the canines' movements without a jerking motion. This action frees the shoulders and arms from strain, thereby reducing injury to the limbs of the user.

As previously described, the cross body nature of the canine handling apparatus 10 distributes the weight evenly around the large mass of the user's back and the lower the center of gravity of the pulling motion increases the ability of the user to hold and control the canine. The configuration of the strap 12 also prevents the strap 12 from digging into the shoulder or back of the user.

The canine handling apparatus 10 is a hands free canine walking “body sling” has allows the user or canine owner the ability to function as if he or she were not connected to their canine. Having their hands free allows the user or canine owner the safety of using both hands in case of a fall whether in ideal conditions or at risk conditions such as hiking in the woods or walking on an icy sidewalk. The canine handling apparatus 10 also allows the canine owner the ability to use both hands in the cleanup of their canine's waste. With the addition of the storage pouch 50 attached to the lower portion of the canine handling apparatus 10, the user or canine owner has a place to store canine waste bags prior to their use and after their use. Once the canine is finished the owner can easily pull out a waste bag from the slot 60 in the storage pouch 50 and pick up the canine's waste. The used bag and waste can then be stored in the storage pouch 50 and sealed for later removal and proper disposal when the user or owner returns from his or her journey.

The canine handling apparatus 10 generally has a storage pouch 50 attached thereto. Other storage pouches or devices may be added at the discretion of the user according to their personal needs. Additional storage pouches or devices are often mounted on the front section 14 of the canine handling apparatus 10 to allow the rear section 16 to be unobstructed so the user can sit down while wearing the canine handling apparatus 10. The design of the front section 14 is such that pouches can easily be slipped on over the webbing above and below the center release buckles 22, 24 by releasing the webbing from the double slide web engaging members 28.

Using the canine handling apparatus 10 keeps the canine at a consistent distance from the user which eliminates the problem of the canine reaching or pulling away from the user's arms when the arms are not fully extended. With known canine walking device, the action of the canine walker is to pull the leash with his or her hands back to the body shortening the gap by about 2 feet from the full distance of ones reach when a canine charges at another canine, animal or person. This is a common problem with canine walking and canine bite attacks. However, as the user of the canine handling apparatus 10 is always at full extension, because there is no use of the hands, the canine can never increase its distance to an on-corner by pulling at the owners hands thus gaining approximately two feet of distance to the victim and creating an attack scenario.

While the invention has been described with reference to a preferred embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. An apparatus for walking a canine, the device comprising:
a wearable strap for positioning over a shoulder and across a torso of a user, the strap having a front portion positioned over a front of the user and a back portion positioned over a back of the user;
an attachment device positioned between the front portion and the back portion, the attachment device positioned at a bottom of the strap and configured to receive a leash therein;
a storage pouch releasably attached to the strap, the storage pouch configured to store and dispense waste bags and for receiving and containing waste bags filled with waste;
the strap is configured to rotate around the shoulder of the user to move from front to back between approximately a 4 o'clock position of the user and an 8 o'clock positions of the user, the strap eliminates direct pressure on the user from the canine and provides the user with the ability to prepare for the canines' movements without a jerking motion, the strap distributes forces associated with the canine pulling evenly around the torso of the user, eliminating strain on a shoulder and arms of the user.

2. The apparatus as recited in claim 1, wherein the strap has an approximately 2 inch wide.

3. The apparatus as recited in claim 1, wherein the front portion of the strap has one or more first adjustment slides which allow the strap to be adjusted to properly fit the user's body.

4. The apparatus as recited in claim 1, wherein release buckles are provided in the front portion of the strap, the release buckles provide a quick safety release when the user must quickly exit the apparatus.

5. The apparatus as recited in claim 4, wherein at least one of the release buckles has resiliently deformable latches such that the latches are resiliently deformed by a mating buckle allowing the latches to be snapped into position in the mating buckle.

6. The apparatus as recited in claim 4, wherein the release buckles have double slide web engaging members provided thereon for removably attaching the front portion of the strap to the release buckles.

7. The apparatus as recited in claim 3, wherein a second attachment device is positioned between the front portion of the strap and the back portion at a top of the apparatus.

8. The apparatus as recited in claim 7, wherein the attachment device and the second attachment device are D-rings.

9. The apparatus as recited in claim 7, wherein one or more second adjustment slides are provided proximate the second attachment device, the second adjustment slides allow the second attachment device to be properly positioned as a length of the strap is adjusted.

10. The apparatus as recited in claim 1, wherein an accessory attachment device is provided on the strap.

11. The apparatus as recited in claim 1, wherein the storage pouch has a cylindrical storage compartment with a side wall, a bottom wall and an open top, the bottom wall has an opening or slot provided therein.

12. The apparatus as recited in claim 11, wherein the storage pouch has a pull cord provided proximate the open top, the pull cord allows the top to be pulled closed as needed.

13. The apparatus as recited in claim 1, wherein the storage pouch has attachment strips extending therefrom, the attachment strips are wrapped around the back portion of the strap and secured thereto.

14. The apparatus as recited in claim 1, wherein additional storage pouches are positioned on the strap, the additional storage pouches used to carry items other than waste bags.

15. The apparatus as recited in claim 1, wherein the apparatus or the storage pouch includes reflective panels, painted areas or fibers which are visible at night or in less than ideal conditions.

16. An apparatus for walking an animal, the device comprising:
a wearable strap for positioning over a shoulder and across a torso of a user, the strap having a front portion and a back portion;
an attachment device positioned between the front portion and the back portion, the attachment device positioned at a bottom of the strap and configured to receive a leash therein;
a storage pouch releasably attached to the strap, the storage pouch configured to store and dispense waste bags and for receiving and containing waste bags filled with waste;
release buckles provided in the front portion of the strap, the release buckles provide a quick safety release when the user must quickly exit the canine handling apparatus;
wherein the strap is configured to rotate around the shoulder of the user to move from front to back between approximately a 4 o'clock position of the user and an 8 o'clock positions of the user, the strap eliminates direct pressure on the user from the canine and provides the user with the ability to prepare for the canines' movements without a jerking motion, the strap distributes forces associated with the canine pulling evenly around the torso of the user, eliminating strain on a shoulder and arms of the user.

17. The apparatus as recited in claim 16, wherein the strap has an approximately 2 inch wide webbing, the strap is configured to rotate around the torso of the user when a canine pulls forward or back, the strap frees the user's shoulders and arms from strain, thereby minimizing injury to the shoulders and arms and distributes force associated with the canine pulling evenly around a large mass of the user's torso and back.

18. The apparatus as recited in claim 17, wherein the front portion of the strap has one or more first adjustment slides which allow the strap to be adjusted to properly fit the user's body.

19. The apparatus as recited in claim 18, wherein a second attachment device positioned between the front portion of the strap and the back portion at a top of the apparatus.

20. The apparatus as recited in claim 19, wherein one or more second adjustment slides are provided proximate the second attachment device, the second adjustment slides allow the second attachment device to be properly positioned as the length of the strap is adjusted.
